(19) United States
(12) Patent Application Publication
(10) Pub. No.: US 2013/0117092 A1
(43) Pub. Date: May 9, 2013

(54) LOYALTY AWARDS FOR DATA USAGE THROUGH TEMPORARY QoS UPGRADES

(71) Applicants: Yigang Cai, Naperville, IL (US); Xiangyang Li, Beijing (CN)

(72) Inventors: Yigang Cai, Naperville, IL (US); Xiangyang Li, Beijing (CN)

(73) Assignee: ALCATEL LUCENT, Paris (FR)

(21) Appl. No.: 13/808,048

(22) PCT Filed: Jul. 2, 2010
(86) PCT No.: PCT/CN10/74903

§ 371 Date: Jan. 2, 2013

(51) Int. Cl. G06Q 30/02

(52) U.S. Cl. CPC G06Q 30/0231
USPC 705/14.31

(57) ABSTRACT

Systems and methods are disclosed for providing temporary QoS upgrades as loyalty awards. In one embodiment, an Online Charging System (OCS) stores account information for end users that access data services provided by a packet core network. The OCS receives a request involving a data service of an end user from the packet core network. In response to the request, the OCS determines that the end user qualifies for a loyalty award based on the account information for the end user. The OCS then grants a temporary QoS upgrade for the end user as the loyalty award, and transmits an indication of the temporary QoS upgrade to the packet core network. Based on the indication of the temporary QoS upgrade, the packet core network is able to enforce the temporary QoS upgrade as the end user accesses one or more data services.

### FIELD OF THE INVENTION

The invention is related to the field of communication systems and, in particular, to providing loyalty awards through temporary QoS upgrades.

### BACKGROUND

Service providers typically provide numerous voice and data services to subscribers. Examples of voice services are voice calls, call forwarding, call waiting, etc. Examples of data services are streaming audio, streaming video, Voice over IP (VoIP), online gaming, and IP-TV. The data services are managed by a packet core network, which interfaces the end user with external packet networks such as the interne. Some examples of packet core networks are a GPRS core network, an Evolved Packet Core (EPC) network, etc. An end user uses a mobile device, such as a cell phone, a personal data assistant, a smart phone, etc, to connect with a Radio Access Network (RAN). The RAN may be a packet-based network that provides IP connectivity, which is also referred to as an IP Connectivity Access Network (CAN). The RAN in turn connects to the packet core network in order to provide the end user with access to the data services.

When the mobile device initiates a data session (e.g., an IP-CAN session), the session request from the mobile device includes a description of the requested data service (e.g., online gaming, IP-TV, etc). The packet core network authenticates the mobile device and determines which data services the mobile device is authorized to receive. If the requested service is authorized, then the packet core network reserves a bearer path (e.g., an IP CAN bearer) of a defined capacity, delay, and bit error rate. A flow of packets may then begin for the service, which is referred to as a service data flow.

The service providers typically implement Policy and Charging Control (PCC) within their networks. Policy control refers to the process of controlling the bearer path for service data flows. For example, policy control includes bearer establishment, Quality of Service (QoS) control, and gating control (blocking or allowing packets to pass). Charging control refers to the process of associating packets of a service data flow to a charging key or identifier, and applying online charging and/or offline charging as appropriate. The service providers define PCC rules that may be used for data services that are requested by end users.

The 3rd Generation Partnership Project (3GPP, 3GPP2) has defined a PCC architecture for packet core networks. One example of a PCC architecture is described in 3GPP TS 23.203 (Release 9). The PCC architecture suggested by the 3GPP includes a Policy and Charging Rules Function (PCRF), a gateway (e.g., a GGSN or packet data gateway) comprising a Policy and Charging Enforcement Function (PCEF), an application function (AF), a Bearer Binding and Event Reporting Function (BBERF), a Subscription Profile Repository (SPR), an Online Charging System (OCS) comprising a Service Data Flow based Credit Control (SDFBCC) function, and an Offline Charging System (OFCS). As a brief description of some of the elements of the PCC architecture, the PCRF makes policy control decisions and flow-based charging control decisions to select which PCC rules to implement for a service data flow. The PCEF in the gateway provides service data flow detection, user plane traffic handling, QoS handling, service data flow measurement, and online/offline charging interactions. The SPR stores subscriber data and subscription related information, such as in a subscriber profile. The SDFBCC performs online credit control functions within the OCS, such as reserving credit, granting quotas, etc.

According to 3GPP TS 23.203, the PCC rules for QoS control are determined at the PCRF with following factors: traffic information, a subscriber profile (subscription data), and the capabilities of the mobile device (UE) of the end user. The PCRF selects an authorized QoS that applies for the end user, and provides the authorized QoS to the PCEF in the PCC rules. The PCEF then enforces the authorized QoS for service data flows that are established for data services provided to the end user.

### SUMMARY

Embodiments described herein provide temporary QoS upgrades to an end user as a loyalty award. Service providers may desire to set up a loyalty program that offers awards or rewards to customers for usage of the network. For example, typical loyalty programs offer bonus minutes or free air time as an award. According to the embodiments herein, a loyalty program offers a temporary QoS upgrade as a loyalty award. For example, if an end users recharges his/her prepaid account with $200, the service provider may grant the end user a temporary QoS upgrade from 2048 kbps to 10 Mbps. Thus, the network access speed is temporary increased so that the end user may receive enhanced data services for a period.

One embodiment comprises an Online Charging System (OCS) that is able to grant temporary QoS upgrades as a loyalty award. The OCS includes a storage system that stores account information for end users that access data services provided by a packet core network. The OCS further includes a control system that receives a request from the packet core network involving a data service of an end user. In response to the request, the control system determines that the end user qualifies for a loyalty award based on the account information for the end user that is stored in the storage system. The control system then grants a temporary QoS upgrade for the end user as the loyalty award, and transmits an indication of the temporary QoS upgrade to the packet core network. Based on the indication of the temporary QoS upgrade, the packet core network is able to enforce the temporary QoS upgrade as the end user accesses one or more data services.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication system in an exemplary embodiment.

FIG. 2 is a flow chart illustrating a method of granting a temporary QoS upgrade as a loyalty award in an exemplary embodiment.

FIG. 3 is a flow chart illustrating a method of defining a period for a temporary QoS upgrade in an exemplary embodiment.

FIG. 4 illustrates an LTE/EPC network in an exemplary embodiment.

FIG. 5 is a message diagram illustrating an example of providing a loyalty award as a temporary QoS upgrade at session initiation in an exemplary embodiment.

FIG. 6 is a message diagram illustrating an example of providing a loyalty award as a temporary QoS upgrade mid-session in an exemplary embodiment.

FIG. 7 is a message diagram illustrating an example of providing a loyalty award as a temporary QoS upgrade when requesting PCC rules in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

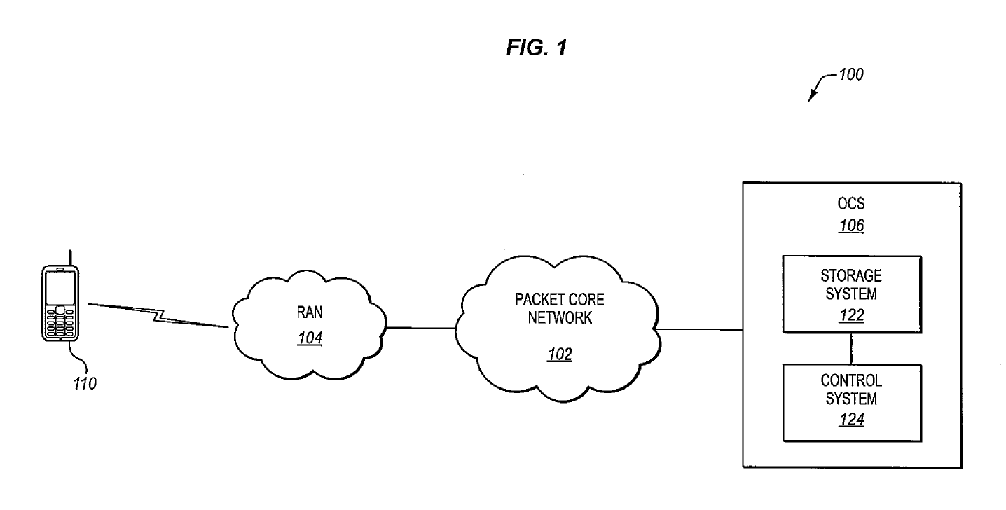

FIG. 1 illustrates a communication system 100 in an exemplary embodiment. Communication system 100 includes a packet core network 102 (also referred to as a packet-based core network or a packet-switched core network) that is configured to provide data services through the transport of packets (as opposed to circuit-switched networks). Some examples of packet core network 102 include a General Packet Radio Service (GPRS) core network, an Evolved Packet Core (EPC) network, etc. Packet core network 102 connects to a Radio Access Network (RAN) 104 and an Online Charging System (OCS) 106. RAN 104 uses radio access technology to interface mobile devices, such as mobile device 110, with a packet core network 102. Some examples of radio access technologies are GSM and UMTS. RAN 104 may also be a packet-based network that provides IP connectivity, such as an IP-CAN. OCS 106 comprises any system, server, or function configured to allow service providers to charge their customers, in real time, based on service usage. In other words, OCS 106 provides prepaid functionality to the customers of system 100.

In this embodiment, OCS 106 is able to grant loyalty awards to end users in the form of QoS upgrades. QoS refers to a certain level of performance for a data flow that is provided or guaranteed by a network under the subscription of the end user. For example, the level of performance may include a bit rate, delay, jitter, packet dropping probability, and/or bit error rate. QoS upgrades thus refer to increasing the QoS provided to a mobile device of an end user. In order to implement QoS upgrades as a loyalty award, OCS 106 includes a storage system 122 and a control system 124. Storage system 122 comprises any system, server, or function configured to store account information for end users that access data services provided by packet core network 102. Control system 124 comprises any system, server, or function configured to grant temporary QoS upgrades as a loyalty award based on the account information. A further description of the operation of OCS 106 is provided below.

Assume for example that a mobile device 110 is able to access data services through RAN 104. In order to access a data service, mobile device 110 sends a request to initiate a data session to RAN 104. The session initiation request includes a description (e.g., SDP description) of a data service being requested. For example, if the data service is a VoIP call, then the session description will specify a VoIP call along with other session parameters. When the data service is requested, packet core network 102 will make a PCC decision for the data service, and enforce PCC rules stemming from the PCC decision. The PCC decision includes an authorized QoS for the data service. For example, assume that the authorized QoS includes a bit rate of 2048 kbps downlink and 384 kbps uplink.

Packet core network 102 may then establish one or more service data flows for the requested data service, and an end user of mobile device 110 may begin to receive the data service. At the beginning of the data service, during the data service, and/or at the end of the data service, packet core network 102 (i.e., the network nodes in packet core network 102) transmits credit requests to OCS 106 for credit control. For example, packet core network 102 may transmit Diameter Credit Control Requests (CCR) [INITIAL, UPDATE, TERMINATE] to OCS 106. As part of providing credit control, OCS 106 rates the data service and grants credit quotas based on the rating. OCS 106 also transmits credit responses (or answers) back to packet core network 102 so that network nodes (not shown) in packet core network 102 may provide budget control for the data service based on the granted quotas. By granting the credit quotas, OCS 106 is able to monitor the usage of the end user for accessing data services. The usage is stored in storage system 122 in the form of account information. Because OCS 106 stores account information for the end user, OCS 106 is able to grant loyalty awards to the end users as follows.

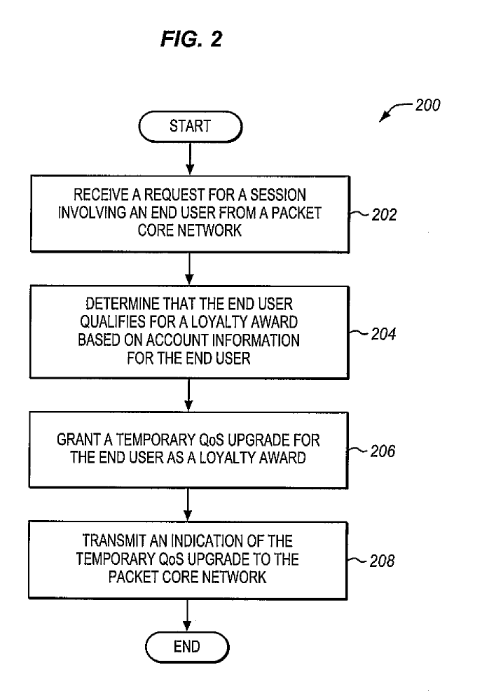

FIG. 2 is a flow chart illustrating a method 200 of granting a temporary QoS upgrade as a loyalty award in an exemplary embodiment. The steps of method 200 are described with reference to communication system 100 in FIG. 1, although method 200 may be performed in other networks or systems. The steps of the flow charts described herein are not all inclusive and may include other steps not shown. The steps may also be performed in an alternative order.

In step 202, control system 124 receives a request from packet core network 102 involving a data service of the end user. The request may be a credit request (e.g., a Diameter CCR), a request for PCC rules, or some other request that is sent by packet core network 102 to OCS 106. The request in step 202 may include an authorized QoS for the data service that was determined as part of the PCC decision.

In response to the request, control system 124 determines that the end user qualifies for a loyalty award based on the account information for the end user in step 204. In determining that the end user qualifies for a loyalty award, control system 124 may process loyalty management rules and the account information to determine if the end user qualifies for an award. The loyalty management rules may define that the end user qualifies for a loyalty award if the end user replenishes a prepaid account, the end user reaches a threshold of call minutes/data volume, etc. For example, if the end user replenishes his/her prepaid account with $200, then the loyalty management rules may define that the end user qualifies for a loyalty award. If the end user consumes 50 GBs of data during a time period, then the loyalty management rules may define that the end user qualifies for a loyalty award. The loyalty management rules may further include additional conditions that indicate whether the end user qualifies for a loyalty award, such as time of day, day of week, service type, service data flow identifier, location, device type, blocked times (e.g., high traffic hours), blocked data services (e.g., movie downloads), or other conditions.

In step 206, control system 124 grants a temporary QoS upgrade for the end user as the loyalty award. For example, control system 124 may grant an increased bit rate from 2048 kbps downlink and 384 kbps uplink to 10 Mbps downlink and a 2 Mbps uplink. The QoS upgrade is temporary in this embodiment as the upgrade lasts for a period (e.g., 24 hours, 20 GB of usage, etc). After the period expires, the QoS provided to the end user is restored to the originally authorized QoS. For example, after the period expires, the bit rate is restored to 2048 kbps downlink and 384 kbps uplink.

In step 208, control system 124 transmits an indication of the temporary QoS upgrade to packet core network 102. Control system 124 may transmit the indication of the temporary QoS upgrade to packet core network 102 in a variety of ways. In one embodiment, control system 124 may send the indication in a credit response (e.g., Diameter CCA). In another embodiment, control system 124 may send the indication in charging rules that are sent to packet core network 102.

Based on the indication of the temporary QoS upgrade, packet core network 102 is able to enforce the temporary QoS upgrade as the end user accesses one or more data services. The temporary QoS upgrade takes precedence over the authorized QoS defined in the PCC rules that are enforced by packet core network 102. Thus, the end user receives the benefit of an upgraded QoS when receiving the requested data service and possibly other data services.

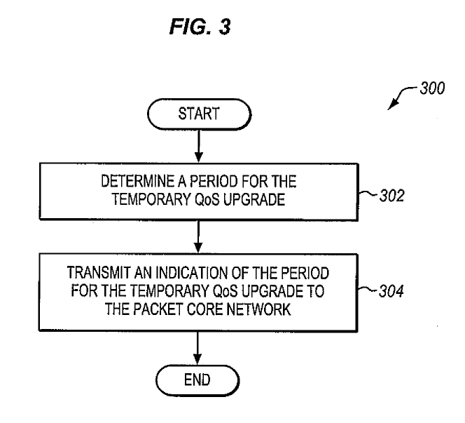

In addition to granting the temporary QoS upgrade, OCS 106 may also define the period for which the temporary QoS upgrade applies. FIG. 3 is a flow chart illustrating a method 300 of defining a period for the temporary QoS upgrade in an exemplary embodiment. In step 302, control system 124 determines a period for the temporary QoS upgrade. In determining the period, control system 124 may again process the loyalty management rules and the account information. The determined period may be time based. For example, the determined period may be 1 hour, 2 hours, 12 hours, 24 hours, etc. The determined period may additionally or alternatively be usage based. For example, the determined period may be 1 GB of data, 2 GBs of data, etc. In step 304, control system 124 transmits an indication of the period to packet core network 102. Control system 124 may transmit the indication of the period to packet core network 102 in a credit response (e.g., Diameter CCA), in charging rules that are sent to packet core network 102, etc. Based on the indication of the period, packet core network 102 is able to enforce the temporary QoS upgrade for the determined period. After the period expires, packet core network 102 enforces the authorized QoS that was originally defined in the PCC rules.

When control system 124 grants a temporary QoS upgrade for the end user as the loyalty award, control system 124 may also transmit a notification of the temporary QoS upgrade to the end user. For example, control system 124 may initiate a text message (e.g., SMS or MMS) destined for mobile device 110 of the end user. The text message displays the upgraded QoS and possibly the period for which the upgraded QoS applies. Control system 124 may send the notification in a variety of other ways. The notification informs the end user that the temporary QoS upgrade is available. Thus, the end user may take full advantage of the temporary QoS upgrade to access data services, especially those data services that are bandwidth intensive. For example, when a temporary QoS upgrade is available, the end user may choose to play an online game or watch a high definition IP-TV program.

When the end user is notified of the temporary QoS upgrade, the end user may request use of the upgraded QoS on-demand. For example, the end user may initiate an on-demand request on mobile device 110, may initiate an on-demand request through a web-based interface, etc. Packet core network 102 may wait to enforce the temporary QoS upgrade until the end user has specifically requested use of the temporary QoS upgrade.

### Example

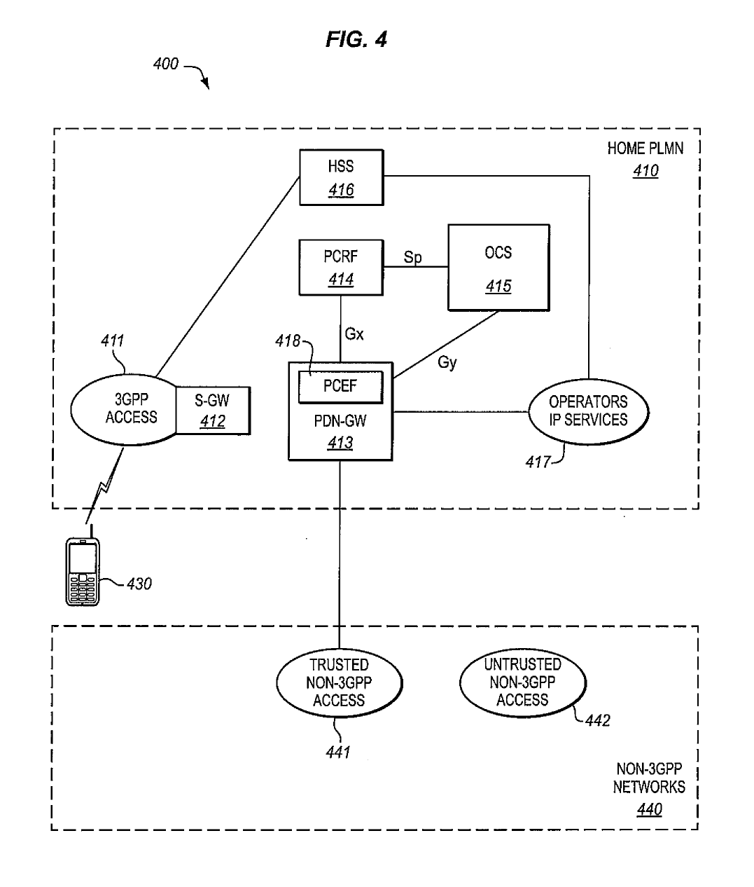

FIGS. 4-7 illustrate an example of a Long Term Evolution/Evolved Packet Core (LTE/EPC) network implementing loyalty awards through temporary QoS upgrades. FIG. 4 illustrates an LTE/EPC network 400 in an exemplary embodiment. LTE/EPC network 400 includes a home Public Land Mobile Network (PLMN) 410 and one or more non-3GPP networks 440. Home PLMN 410 represents a packet core network where an end user of a mobile device 430 has subscribed to a service plan. Home PLMN 410 includes a 3GPP access network 411 and the following network nodes: a serving gateway (S-GW) 412, a packet data network gateway (PDN-GW) 413, a Policy and Charging Rules Function (PCRF) 414, an Online Charging System (OCS) 415, a Home Subscriber Server (HSS) 416, and operator's IP services 417 (e.g., IMS). PDN-GW 413 includes a Policy and Charging Enforcement Function (PCEF) 418.

PCEF 418, PCRF 414, and OCS 415 form a PCC architecture, such as an architecture described in 3GPP 23.203. PCEF 418 interfaces with PCRF 414 via a Gx reference point. PCEF 418 also interfaces with OCS 415 via a Gy reference point. PCRF 414 may interface with OCS 415 via a Diameter Sp reference point. The PCC architecture may further include a Bearer Binding and Event Reporting Function (BBERF), a subscription Profile Repository (SPR), and an application function (AF) as is known for PCC architectures.

Non-3GPP network 440 includes a trusted non-3GPP access network 441 and an un-trusted non-3GPP access network 442.

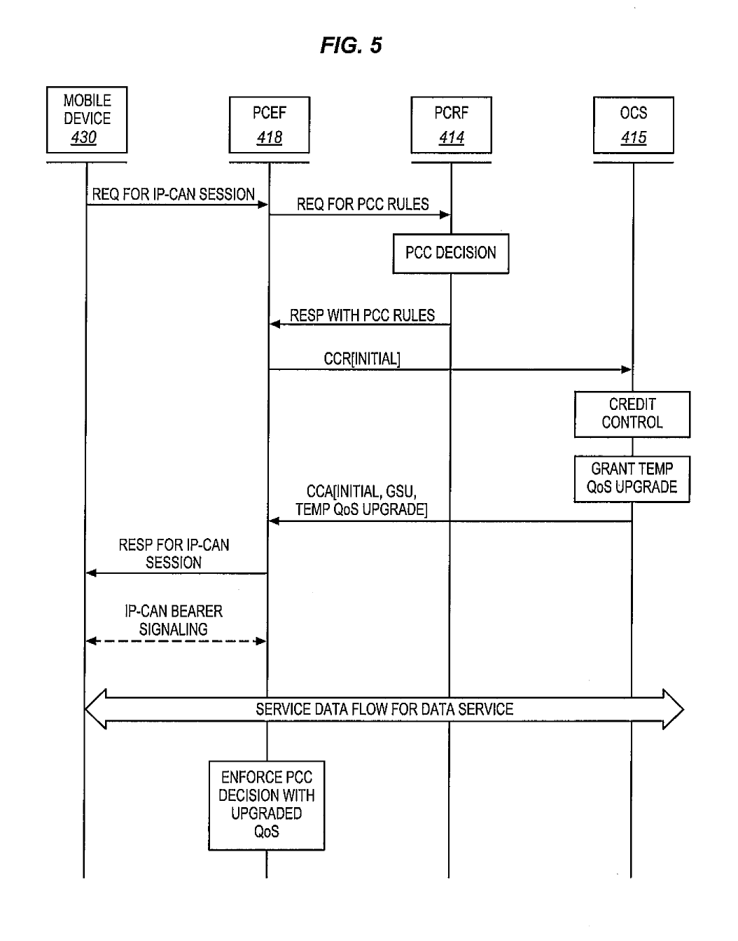

Assume for this embodiment that mobile device 430 wants to establish a data session. FIG. 5 is a message diagram illustrating an example of providing a loyalty award as a temporary QoS upgrade at session initiation in an exemplary embodiment. The message diagram illustrates Diameter messaging used within LTE/EPC network 400 though alternative embodiments may utilize other messaging protocols.

To start in FIG. 5, mobile device 430 exchanges messages with PDN-GW 413 to request an IP-CAN session. For example, mobile device 430 may send a SIP message, such as a SIP INVITE, to request the IP-CAN session. The request from mobile device 430 includes a session description of a desired data service. PCEF 418 in PDN-GW 413 receives the request to establish the IP-CAN session, and transmits a request for PCC rules (indication of IP-CAN session establishment) to PCRF 414 over the Gx reference point. The request for PCC rules may include a variety of data or parameters that may be used to make a PCC decision. For example, the request may include a subscriber ID (e.g., in a Subscription-ID AVP), the type of RAN connected to mobile device 430, the type of the radio access technology used for 3GPP access network 411, information on an external packet data network (if available), the IP address of mobile device 430, etc.

PCRF 414 receives the request for PCC rules from PCEF 418. PCRF 414 is charged with making a PCC decision for the data session. Before making the PCC decision, PCRF 414 may retrieve subscriber data, such as a subscriber profile, for mobile device 430. PCRF 414 may retrieve the subscriber data from HSS 416, from OCS 415, or from another node such as an SPR. PCRF 414 then processes the subscriber data and charging rules to make a PCC decision for the data service. The PCC decision includes an authorized QoS for the data service. For example, assume that the authorized QoS includes a bit rate of 2048 kbps downlink and 384 kbps uplink for the requested data service. PCRF 414 then transmits a response or acknowledgement to PCEF 418 that includes the PCC rules resulting from the PCC decision.

Assume for this embodiment that the charging method comprises online charging for the data service. Thus, PCEF 418 needs to request authorization from OCS 415 before a service data flow may be established for the data service. PCEF 418 transmits a Diameter Credit Control Request (CCR)[INITIAL] to OCS 415 over the Diameter Gy reference point. PCEF 418 may insert the authorized QoS in the CCR.

In response to receiving the CCR, OCS 415 identifies an account balance for the end user of mobile device 430 based on a subscriber ID in the CCR. OCS 415 rates the data service and performs credit control based on an account balance of the end user. If the account balance for the end user is too low, then OCS 415 may reject the reservation request. However, if the account balance is sufficient, then OCS 415 grants a quota of service units based on the rating and the account balance.

In addition to providing credit control, OCS 415 also implements loyalty award management. To do so, OCS 415 is able to monitor the usage of the end user for accessing data services. The usage is stored in OCS 415 in the form of account information. OCS 415 is also pre-provisioned with loyalty management rules, which indicate how or when an end user qualifies for a loyalty award. Because OCS 415 stores account information for the end user, OCS 415 is able to grant loyalty awards to the end users.

In response to receiving the Diameter CCR[INITIAL], OCS 415 determines whether the end user qualifies for a loyalty award based on the account information, the loyalty management rules, and possibly the authorized QoS. If the end user qualifies (which is true in this example), then OCS 415 grants a temporary QoS upgrade for the end user as the loyalty award. For example, OCS 415 may grant an increased bit rate from 2048 kbps downlink and 384 kbps uplink to 10 Mbps downlink and 2 Mbps uplink. The QoS upgrade is temporary in this embodiment as the upgrade lasts for a period (e.g., 24 hours or 2 GB of data). The loyalty award is thus triggered in this example in response to receiving a CCR[INITIAL] for the requested data service.

OCS 415 generates a Diameter Credit Control Answer (CCA)[INITIAL] for credit control, and inserts the granted service units (GSU) in the CCA[INITIAL]. In addition, OCS 415 inserts an indication of the temporary QoS upgrade in the CCA[INITIAL], and may also insert a period for which the temporary QoS upgrade applies. OCS 415 then transmits the CCA[INITIAL] to PCEF 418.

PCEF 418 receives the CCA[INITIAL], and processes the credit quota and the indication of the temporary QoS upgrade. With the credit granted by OCS 415, PCEF 418 sends a response to mobile device 430 for establishing the IP-CAN session. This may include exchanging further signalling with mobile device 430. PCEF 418 may then allow a service data flow for the data service to begin. With the service data flow initiated, PCEF 418 enforces policy control through gate enforcement and QoS enforcement. Because the temporary QoS upgrade was granted by OCS 415 as a loyalty award, PCEF 418 enforces the temporary QoS upgrade for the period defined by OCS 415. The temporary QoS takes precedence over the authorized QoS that is included in the PCC rules. Thus, in this example, mobile device 430 receives the upgraded QoS at the beginning of the session, because the temporary QoS upgrade is enforced instead of the authorized QoS from the PCC rules.

PCEF 418 also monitors the usage of mobile device 430 (e.g., the number of bytes received/transmitted) and decrements the granted quota of service units accordingly. If the granted quota is consumed, then PCEF 418 may request another quota from OCS 415 by sending a CCR[UPDATE].

If the period expires for the temporary QoS upgrade, then PCEF 418 reverts back to the authorized QoS in the PCC rules. For example, PCEF 418 reverts back to a bit rate of 2048 kbps downlink and 384 kbps uplink. If the period for the temporary QoS upgrade does not expire during the requested data service, then the temporary QoS upgrade may be available for subsequent data services requested by mobile device 430.

In the embodiments described herein (such as FIG. 5), the Diameter Gy interface between PCEF 418 and OCS 415 may be enhanced with a new Attribute Value Pair (AVP) designated for the indication of the temporary QoS upgrade. In one example, the new AVP may be added to the Multiple-Services-Credit-Control (MSCC) group AVP. 3GPP TS 32.299-900 defines the MSCC group AVP that is used for a Diameter CCA. The enhanced interface as described herein includes a “QoS-information” AVP in the MSCC group AVP. Thus, the MSCC group with the new “QoS-Information” AVP may have the following structure:

<Multiple-Services-Credit-Control>::=<AVP Header: 456>
[Granted-Service-Unit]
[Requested-Service-Unit]
[Used-Service-Unit]
[Service-Identifier]
[Rating-Group]
[G-S-U-Pool-Reference]
[Validity-Time]
[Result-Code]
[Final-Unit-Indication]
[Time-Quota-Threshold]
[Volume-Quota-Threshold]
[Unit-Quota-Threshold]
[Quota-Holding-Time]
[Quota-Consumption-Time]
[Reporting-Reason]
[Trigger]
[PS-Furnish-Charging-Information]
[Refund-Information]
[AF-Correlation-Information]
[Envelope]
[Envelope-Reporting]
[Time-Quota-Mechanism]
[Service-Specific-Info]
[QoS-Information]

The “QoS-Information” AVP, as defined in 3GPP TS 23.212-840, is as follows:

QoS-Information::=<AVP Header: 1016>
[QoS-Class-Identifier]
[Max-Requested-Bandwidth-UL]
[Max-Requested-Bandwidth-DL]
[Guaranteed-Bitrate-UL]
[Guaranteed-Bitrate-DL]
[Bearer-Identifier]
[Allocation-Retention-Priority]
[APN-Aggregate-Max-Bitrate-UL]
[APN-Aggregate-Max-Bitrate-DL]

When using the enhanced interface, PCEF 418 inserts an indication of the authorized QoS in the “QoS-Information” AVP of the Diameter CCR that is sent to OCS 415. In turn, OCS 415 inserts an indication of the temporary QoS upgrade in the “QoS-Information” AVP of the Diameter CCA that is sent to PCEF 418. Prior to the enhancement, the Diameter Gy interface would not have been able to transport the QoS information between PCEF 418 and OCS 415. Although the enhancement to the Gy interface is described in relation to FIG. 4, those skilled in the art will appreciate that a similar enhancement may be applied to the system shown in FIG. 1.

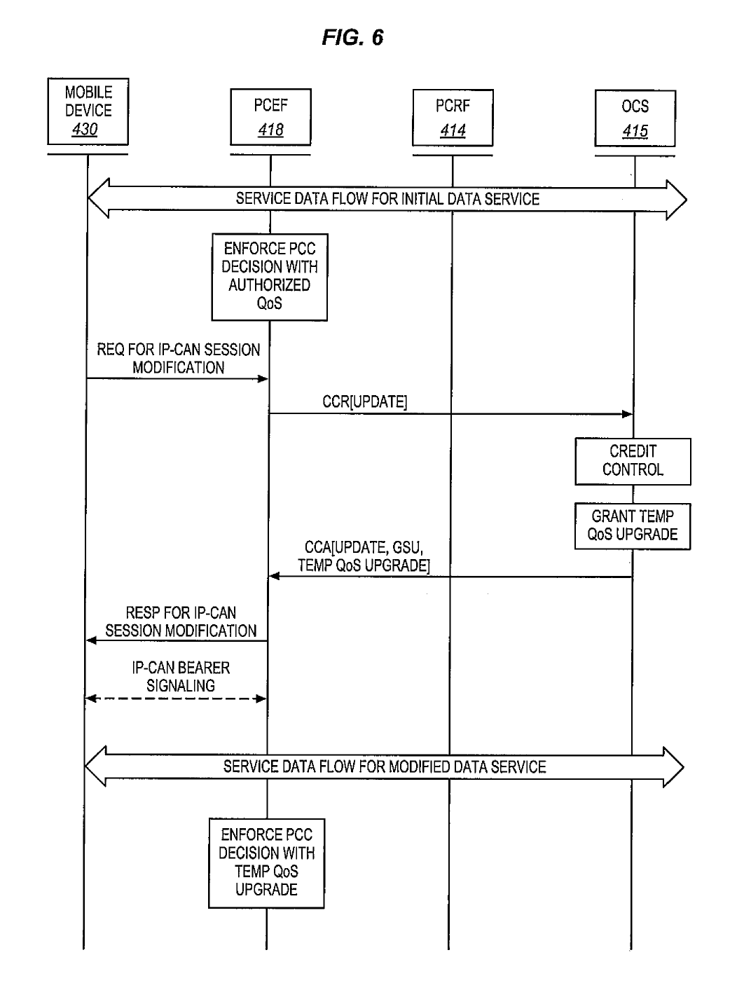

The example in FIG. 5 shows how the temporary QoS upgrade may be granted at the beginning of a session in response to a Diameter CCR[INITIAL]. In other examples, the temporary QoS upgrade may be granted mid-session in response to a Diameter CCR[UPDATE], as is illustrated in FIG. 6.

FIG. 6 is a message diagram illustrating an example of providing a loyalty award as a temporary QoS upgrade mid-session in an exemplary embodiment. In this embodiment, a service data flow has been established for a data service requested by mobile device 430. One example of the data service may be a VoIP call. For the service data flow, PCEF 418 is enforcing the QoS that was authorized in the PCC rules by PCRF 414. Assume at some point that mobile device 430 sends a request to modify the data service (e.g., from the VoIP call to an online game). PCEF 418 receives the request either from mobile device 430 or from another network node, such as an application function (AF) which is not illustrated in FIG. 4. In response to the modification request, PCEF 418 transmits a CCR[UPDATE] to OCS 415 over the Diameter Gy reference point that includes a service indicator for the new data service (e.g., online gaming). PCEF 418 may insert an indication of the authorized QoS in the Diameter CCR.

OCS 415 receives the CCR[UPDATE], and identifies an account balance for the end user of mobile device 430 based on a subscriber ID in the CCR[UPDATE]. OCS 415 rates the modified data service and performs credit control based on an account balance of the end user. If the account balance is sufficient, then OCS 415 grants a quota of service units based on the rating and the account balance.

In addition to providing credit control, OCS 415 also implements loyalty award management mid-session. To do so, OCS 415 determines whether the end user qualifies for a loyalty award based on the account information, the loyalty management rules, and possibly the authorized QoS. If the end user qualifies (which is true in this example), then OCS 415 grants a temporary QoS upgrade for the end user as the loyalty award. The loyalty award is thus triggered in this example in response to receiving a CCR[UPDATE] for the modified data service.

OCS 415 generates a Diameter CCA[UPDATE] for credit control, and inserts the granted service units (GSU) in the CCA[UPDATE]. In addition, OCS 415 inserts an indication of the temporary QoS upgrade in the CCA[UPDATE], and may also insert a period for which the temporary QoS upgrade applies. OCS 415 then transmits the CCA[UPDATE] to PCEF 418.

PCEF 418 receives the CCA[UPDATE], and processes the credit quota and the indication of the temporary QoS upgrade. With the credit granted by OCS 415, PCEF 418 sends a response to mobile device 430 for modifying the IP-CAN session. This may include exchanging further signalling with mobile device 430. With the service data flow modified, PCEF 418 enforces policy control through gate enforcement and QoS enforcement. Because the temporary QoS upgrade was granted by OCS 415 as a loyalty award, PCEF 418 enforces the temporary QoS upgrade for the period defined by OCS 415 for the modified data service. The temporary QoS takes precedence over the authorized QoS that was enforced before the data service was modified. Thus, in this example, mobile device 430 receives the upgraded QoS for the modified data service (i.e., for the online game), because the temporary QoS upgrade is enforced instead of the authorized QoS from the PCC rules.

If the period expires for the temporary QoS upgrade, then PCEF 418 reverts back to the authorized QoS in the PCC rules. For example, PCEF 418 will revert back to a bit rate of 2048 kbps downlink and 384 kbps uplink. If the period for the temporary QoS upgrade does not expire during the requested data service, then the temporary QoS upgrade may be available for subsequent data services requested by mobile device 430.

The examples in FIGS. 5-6 show how the temporary QoS upgrade may be granted in response to credit requests (e.g., Diameter CCR). In other examples, the temporary QoS upgrade may be granted in response to a request for PCC rules. OCS 415 in FIG. 4 may be extended as compared to the 3GPP standards, and is thus may be referred to as an extended OCS (eOCS). The extended version of OCS 415 stores subscriber-related data and charging rules that may be used by PCRF 414 in making the PCC decision. For example, OCS 415 may include a Service Data Flow based Credit Control (SDFCC) function, which is configured to perform online credit control functions within OCS 415, such as reserving credit, granting quotas, etc. OCS 415 may further include a Subscriber Profile and Service Control Management (SPSCM) function. The SPSCM function is configured to store subscriber-related data, such as a subscriber profile. This data is similar to the data stored in an SPR. The SPSCM function is further configured to store subscriber account data, service-based tariffs, and other charging data for subscribers.

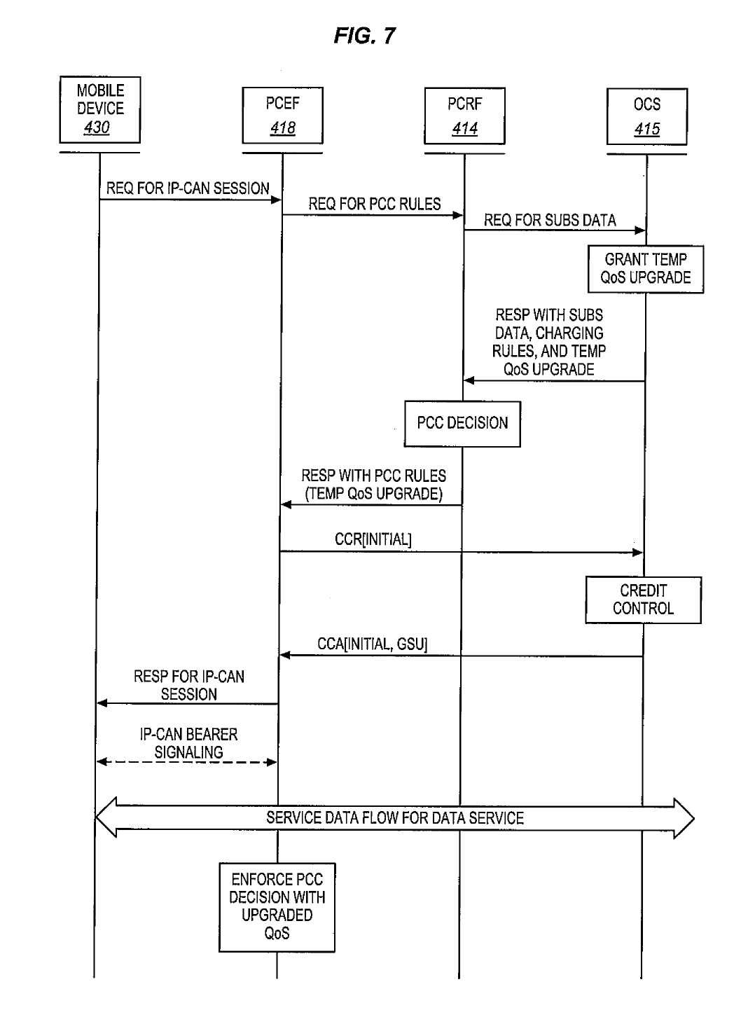

FIG. 7 is a message diagram illustrating an example of providing a loyalty award as a temporary QoS upgrade when requesting PCC rules in an exemplary embodiment. As in FIG. 5, mobile device 430 exchanges messages with PCEF 418, and PCEF 418 receives a request from mobile device 430 to establish the IP-CAN session. PCEF 418 then transmits a request for PCC rules (indication of IP-CAN session establishment) to PCRF 414 over the Gx reference point. PCRF 414 is charged with making a PCC decision for the data session. Before making the PCC decision, PCRF 414 may retrieve subscriber data, such as a subscriber profile, for mobile device 430. Because OCS 415 is extended to include subscriber-related data, PCRF 414 transmits a request for subscriber data and charging rules to OCS 415 over the Sp reference point. The request from PCRF 414 includes the service indicator for the requested data service.

OCS 415 receives the request from PCRF 414. OCS 415 processes the parameters in the request, such as the subscriber ID, and identifies subscriber data or subscriber-related data. For example, OCS 415 may search for a subscriber profile that matches the subscriber ID. OCS 415 also processes the service indicator in the request to select charging rules for the requested data service.

OCS 415 also implements loyalty award management in response to the PCC rules request. To do so, OCS 415 determines whether the end user qualifies for a loyalty award based on the account information and the loyalty management rules. If the end user qualifies (which is true in this example), then OCS 415 grants a temporary QoS upgrade for the end user as the loyalty award. The loyalty award is thus triggered in this example in response to receiving a request for PCC rules.

OCS 415 then transmits a response to PCRF 414 over the Diameter Sp reference point that includes the selected charging rules, the subscriber data, and an indication of the temporary QoS upgrade. The Diameter Sp reference point may be enhanced to include a new AVP for the indication of the temporary QoS upgrade much as the Diameter Gy reference point was enhanced. PCRF 414 processes the subscriber data, the selected charging rules, and the indication of the temporary QoS upgrade to make a PCC decision for the requested data service. PCRF 414 then transmits a response to PCEF 418 that includes the PCC rules resulting from the PCC decision. The PCC rules in this example may include by an indication of the authorized QoS for the requested data service and an indication of the upgraded QoS for the loyalty award. The PCC rules may further include a period for which the QoS upgrade applies.

Assume for this embodiment that the charging method in the PCC rules indicates online charging for the requested data service. Thus, PCEF 418 needs to request authorization from OCS 415 before a service data flow may be established for the data service. Thus, PCEF 418 transmits a Diameter CCR[INITIAL] to OCS 415 over the Diameter Gy reference point. OCS 415 receives the CCR, and identifies an account balance for the end user of mobile device 430 based on a subscriber ID in the CCR. OCS 415 rates the data service and performs credit control based on an account balance of the end user. If the account balance for the end user is too low, then OCS 415 may reject the reservation request. However, if the account balance is sufficient, then OCS 415 grants a quota of service units based on the rating and the account balance. OCS 415 generates a Diameter CCA[INITIAL] for credit control, and inserts the granted service units (GSU) in the CCA[INITIAL]. OCS 415 then transmits the CCA[INITIAL] to PCEF 418.

PCEF 418 receives the CCA[INITIAL], and processes the credit quota and the indication of the temporary QoS upgrade. With the credit granted by OCS 415, PCEF 418 sends a response to mobile device 430 for establishing the IP-CAN session. This may include exchanging further signalling with mobile device 430. PCEF 418 may then allow a service data flow for the data service to begin. With the service data flow initiated, PCEF 418 enforces policy control through gate enforcement and QoS enforcement. Because the temporary QoS upgrade was granted by OCS 415 as a loyalty award, PCEF 418 enforces the temporary QoS upgrade for the period defined by OCS 415. The temporary QoS in the PCC rules takes precedence over the authorized QoS that is included in the PCC rules. Thus, in this example, mobile device 430 receives the upgraded QoS at the beginning of the session, because the temporary QoS upgrade is enforced instead of the authorized QoS.

If the period expires for the temporary QoS upgrade, then PCEF 418 reverts back to the authorized QoS in the PCC rules. For example, PCEF 418 reverts back to a bit rate of 2048 kbps downlink and 384 kbps uplink. If the period for the temporary QoS upgrade does not expire during the requested data service, then the temporary QoS upgrade may be available for subsequent data services requested by mobile device 430.

The above embodiments provide a way for service providers to provide a different type of loyalty award. Instead of just providing free minutes or air time to a loyal end user, the service provider may offer a QoS upgrade. If the end user frequently accesses data services, the QoS upgrade may be desirable to the end user when playing online games, surfing the interne, watching IP-TV, etc.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

What is claimed is:

1. An Online Charging System (OCS) comprising:
a storage system configured to store account information for end users that access data services provided by a packet core network; and
a control system configured to receive a request from the packet core network involving a data service of an end user, to determine that the end user qualifies for a loyalty award based on the account information for the end user, to grant a temporary Quality of Service (QoS) upgrade for the end user as the loyalty award, and to transmit an indication of the temporary QoS upgrade to the packet core network.

2. The OCS of claim 1 wherein:
the control system is further configured to insert the indication of the temporary QoS upgrade in a new AVP of a Diameter Credit Control Answer (CCA) defined for the temporary QoS upgrade, and to transmit the Diameter CCA to the packet core network.

3. The OCS of claim 2 wherein:
the new AVP of the Diameter CCA defined for the indication of the temporary QoS upgrade comprises a QoS-Information AVP defined within a Multiple-Services-Credit-Control (MSCC) group AVP of the Diameter CCA.

4. The OCS of claim 1 wherein:
the control system is further configured to determine a period for the temporary QoS upgrade, and to transmit an indication of the period for the temporary QoS upgrade to the packet core network.

5. The OCS of claim 1 wherein:
the control system is further configured to transmit a notification of the temporary QoS upgrade to the end user.

6. The OCS of claim 1 wherein:
the request comprises a Diameter credit request from the packet core network.

7. The OCS of claim 1 wherein:
the request comprises a request for Policy and Charging Control (PCC) rules from the packet core network.

8. The OCS of claim 1 wherein:
the control system is further configured to process the account information and loyalty management rules to determine that the end user qualifies for the loyalty award, wherein the loyalty management rules include at least one condition for the loyalty award.

9. The OCS of claim 8 wherein:
the at least one condition for the loyalty award includes at least one of a period of time, a data service type, a service data flow identifier, a location, and a device type.

10. A method comprising:
receiving a request involving a data service of an end user in an Online Charging System (OCS) from a packet core network;
determining, in the OCS, that the end user qualifies for a loyalty award based on account information for the end user that is stored in the OCS;
granting a temporary Quality of Service (QoS) upgrade for the end user as the loyalty award; and
transmitting an indication of the temporary QoS upgrade from the OCS to the packet core network.

11. The method of claim 10 wherein transmitting an indication of the temporary QoS upgrade comprises:
inserting the indication of the temporary QoS upgrade in a new AVP of a Diameter Credit Control Answer (CCA) defined for the temporary QoS upgrade; and
transmitting the Diameter CCA from the OCS to the packet core network.

12. The method of claim 11 wherein:
the new AVP of the Diameter CCA defined for the indication of the temporary QoS upgrade comprises a QoS-Information AVP defined within a Multiple-Services-Credit-Control (MSCC) group AVP of the Diameter CCA.

13. The method of claim 10 further comprising:
determining, in the OCS, a period for the temporary QoS upgrade; and
transmitting an indication of the period for the temporary QoS upgrade from the OCS to the packet core network.

14. The method of claim 10 further comprising:
transmitting a notification of the temporary QoS upgrade from the OCS to the end user.

15. The method of claim 10 wherein receiving a request involving a data service of an end user comprises:
receiving a Diameter credit request involving the data service in the OCS from the packet core network.

16. The method of claim 10 wherein receiving a request involving a data service of an end user comprises:
receiving a request for Policy and Charging Control (PCC) rules in the OCS from the packet core network.

17. The method of claim 10 wherein determining that the end user qualifies for a loyalty award based on the account information for the end user comprises:
processing, in the OCS, the account information and loyalty management rules to determine that the end user qualifies for the loyalty award, wherein the loyalty management rules include at least one condition for the loyalty award.

18. The method of claim 17 wherein:
the at least one condition for the loyalty award includes at least one of a period of time, a data service type, a service data flow identifier, a location, and a device type.

19. A Policy and Charging Control (PCC) architecture, comprising:
an online charging system (OCS) configured to store account information for end users that access data services provided by a packet core network;
the OCS is further configured to receive a Diameter credit request involving a service of an end user from a Policy and Charging Rules Function (PCRF) in the packet core network, to determine that the end user qualifies for a loyalty award based on the account information for the end user, to grant a temporary Quality of Service (QoS) upgrade for the end user as the loyalty award, and to transmit an indication of the temporary QoS upgrade to the PCRF in a Diameter credit response.

20. The PCC architecture of claim 19 wherein:
the Diameter credit response comprises a Diameter Credit Control Answer (CCA);
a new AVP is defined in the CCA for the indication of the temporary QoS upgrade; and.
the new AVP for the indication of the temporary QoS upgrade comprises a QoS-Information AVP defined within a Multiple-Services-Credit-Control (MSCC) group AVP of the Diameter CCA.
